(19) United States
(12) Patent Application Publication
(10) Pub. No.: US 2010/0330389 A1
(43) Pub. Date: Dec. 30, 2010

(54) SKIN PASS FOR CLADDING THIN METAL SHEETS

(75) Inventor: Huimin Liu, Northville, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 12/491,427

(22) Filed: Jun. 25, 2009

(51) Int. Cl. B32B 15/01; B21B 1/38

(52) U.S. Cl. 428/600; 72/221

(57) ABSTRACT

According to at least one aspect of the present invention, a method is provided for cladding a thin metal sheet for enhanced formability and manufacturability thereof. In at least one embodiment, the method includes contacting at least one metal cladding layer with the thin metal sheet to form a thin metal sandwich having an original thickness, wherein the metal cladding layer may be a thin metal foil or a plated or deposited thin metal film, and then subjecting the thin metal sandwich to four Skin-Pass steps at an incremental thickness reduction ratio of 25 percent of the total thickness Reduction Ratio per step in four alternating directions. The method provides Skin-Pass processed clad sheet metals with reduced uniaxial pre-strain, improved uniformity in microstructure and material properties along the longitudinal and transversal directions, and enhanced formability and manufacturability.

### BACKGROUND

1. Technical Field

Embodiments of the present invention relate to a method of cladding thin metal sheets for enhanced formability and manufacturability thereof.

2. Background Art

In an effort to eliminate fossil fuel dependency and environmental pollution, automotive Original Equipment Manufacturers (OEMs) have made remarkable strides in developing clean energy vehicles. Noted for zero emission and high energy efficiency, Fuel Cell Vehicles (FCVs) are creating a niche in clean energy vehicle history.

Among the various types of fuel cells evolved, Proton Exchange Membrane Fuel Cells (PEMFCs) have become the most preferred for automotive vehicle propulsion systems due to their cost effectiveness, packaging flexibility and operating conditions more suitable to automotive applications. As a key component in PEMFCs, Metal Bi-Polar Plates (MBPPs) have been increasingly used owing to the many desirable advantages of metals compared to alternative materials.

Unfortunately, once a passivation film forms on a metal plate surface in the harsh environment encountered in a typical PEMFC, the interfacial electrical contact resistance increases, and the leached metallic ions may poison the Proton Exchange Membrane (PEM), causing degradation of the metal plate and PEM, and deterioration of the cell performance and durability. To eliminate or at least alleviate both the contact resistance and corrosion issues, a potential solution is to coat the metal surface with a protective film. However, Pre-Coating of sheet metals largely reduces the formability and manufacturability of the sheet metals, introducing significant restrictions to its applications in MBPP manufacturing.

### SUMMARY

According to at least one aspect of the present invention, a method is provided for cladding a thin metal sheet for enhanced formability and manufacturability thereof. In at least one embodiment, the method includes contacting at least one metal cladding layer with a thin metal sheet to form a thin metal sandwich having an original thickness, wherein the metal cladding layer may be a thin metal foil or a plated or deposited thin metal film, and subjecting the thin metal sandwich to a first compression rolling in a first direction to form a first compressed thin metal sandwich having a first compressed thickness, and then subjecting the first compressed thin metal sandwich to a second compression rolling in a second direction different from the first direction to form a second compressed thin metal sandwich having a second compressed thickness.

In at least another embodiment, the method further includes subjecting the second compressed thin metal sandwich to a third compression rolling in a third direction different from the first or the second direction to form a third compressed thin metal sandwich having a third compressed thickness.

In at least yet another embodiment, the method further includes subjecting the third compressed thin metal sandwich to a fourth compression rolling in a fourth direction different from at least two of the first, second and third directions to form a fourth compressed thin metal sandwich having a fourth compressed thickness.

In at least one particular embodiment, a first thickness difference between the original thickness and the first compressed thickness is equal to a second thickness difference between the first and the second compressed thicknesses.

In at least another particular embodiment, the first thickness difference is equal to a third thickness difference between the second and the third compressed thicknesses.

In at least yet another particular embodiment, the first thickness difference is equal to a fourth thickness difference between the third and the fourth compressed thicknesses.

In at least yet another particular embodiment, the fourth compressed thickness is 95 to 50 percent of the original thickness of the thin metal sandwich.

In at least yet another particular embodiment, the first direction is parallel to a longitudinal axis of the thin metal sheet.

In at least yet another particular embodiment, the second direction is transversal to the longitudinal axis of the thin metal sheet.

In at least yet another particular embodiment, the third direction is transversal to the longitudinal axis of the thin metal sheet and opposite to the second direction.

In at least yet another particular embodiment, the fourth direction is parallel to the longitudinal axis of the thin metal sheet.

According to at least another aspect of the present invention, a method is provided for cladding a thin metal sheet to be used for forming a metal plate. In at least one embodiment, the method includes contacting at least one metal cladding layer with a thin metal sheet to form a thin metal sandwich having an original thickness, wherein the metal cladding layer may be a thin metal foil or a plated or deposited thin metal film, subjecting the thin metal sandwich to a first compression rolling in a first direction to form a first compressed thin metal sandwich having a first compressed thickness, subjecting the first compressed thin metal sandwich to a second compression rolling in a second direction different from the first direction to form a second compressed thin metal sandwich having a second compressed thickness, subjecting the second compressed thin metal sandwich to a third compression rolling in a third direction different from the first or the second direction to form a third compressed thin metal sandwich having a third compressed thickness, and subjecting the third compressed thin metal sandwich to a fourth compression rolling in a fourth direction different from at least two of the first, second and third directions to form a fourth compressed thin metal sandwich having a fourth compressed thickness.

In at least one particular embodiment, a first thickness difference between the original and the first compressed thicknesses is equal to a second thickness difference between the first and the second compressed thicknesses, and equal to a third thickness difference between the second and the third compressed thicknesses, and equal to a fourth thickness difference between the third and the fourth compressed thicknesses. In at least another particular embodiment, the fourth compressed thickness is 95 to 50 percent of the original thickness of the thin metal sandwich.

In at least another embodiment, the method further includes forming a metal plate from the fourth compressed thin metal sandwich.

### BRIEF DESCRIPTION OF THE DRAWINGS

FIG. 1A schematically depicts an exemplary single PEMFC with formed metal plates;

FIG. 1B schematically depicts an exemplary PEMFC stack with formed and joined MBPPs;

FIG. 2 illustrates three potential coating approaches for MBPP applications;

FIG. 3 depicts anisotropy in material microstructure due to extensive uniaxial rolling for gage reduction and cladding in a conventional Cladding process;

FIGS. 4A and 4B collectively show a Skin Pass method, according to embodiments of the present invention, for cladding a thin metal sheet for PEMFC MBPP applications.

### DETAILED DESCRIPTION OF EMBODIMENTS OF THE INVENTION

Reference will now be made in detail to the compositions, embodiments and methods of the present invention known to the inventor. However, it should be noted that the disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of materials, conditions and/or uses are to be understood as modified by the word “about” in describing the broadest scope of the present invention. Practice within the numerical limits stated is generally preferred.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

Over the past decade, automotive OEMs have made remarkable strides in developing clean energy vehicles. While Hybrid Electrical Vehicles (HEVs) with Nickel-Metal Hydride and recently Lithium-Ion batteries have become a commercial reality, a small number of FCVs have also been manufactured for fleet evaluation.

Among the various types of fuel cells evolved, PEMFCs have become the most preferred for automotive vehicle propulsion systems due to their cost effectiveness, packaging flexibility and operating conditions more suitable to automotive applications. As a key component in PEMFCs, MBPPs have been increasingly used in fuel cell stacks and modules assembled thereof. Compared to the early generations of Bi-Polar Plates (BPPs) made of alternative materials such as grafoils and carbon composites, MBPPs exhibit many desirable advantages. For example, MBPPs are more cost-effective and manufacturing-efficient, lighter in weight, thinner in cell pitch and accordingly more compact in resultant stacks and modules, non-permeable, and mechanically stronger, stiffer and more durable.

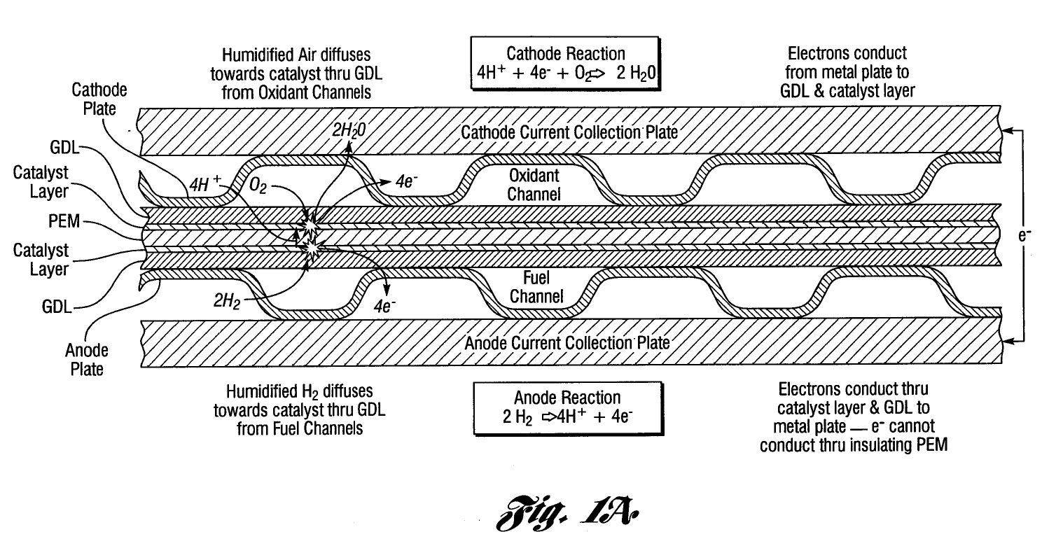

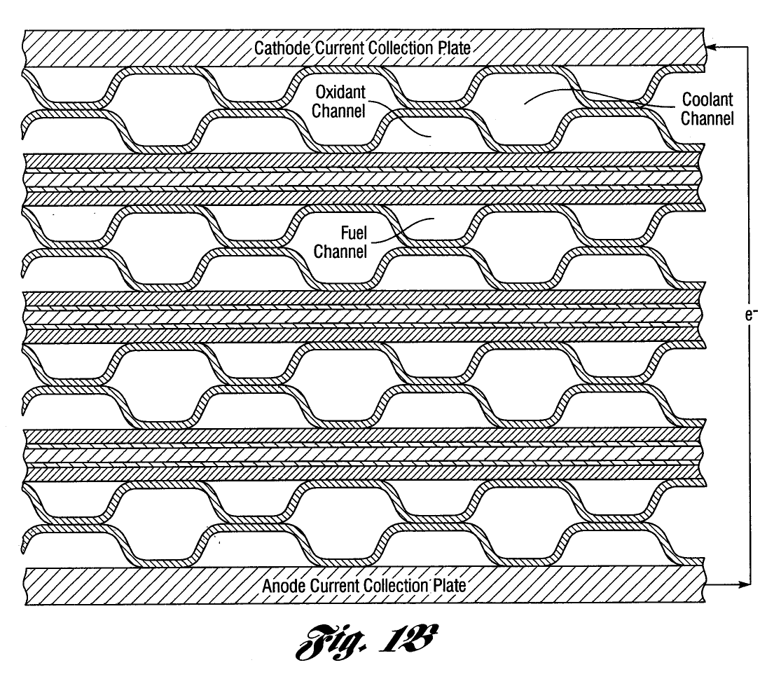

FIGS. 1A and 1B schematically depict an exemplary single PEMFC with formed metal plates and an exemplary PEMFC stack with formed and joined MBPPs, respectively, wherein various components in a PEMFC and stack as well as their functions are indicated.

As illustrated in FIG. 1A, two (2) Single Plates (an Anode Plate and a Cathode Plate) are needed to build a Single Cell. A pair of single plates may be joined together to create a BPP. Multiple BPPs may be stacked, with a Membrane Electrode Assembly (MEA) inbetween, which comprises one (1) PEM coated with catalysts on both sides and two (2) Gas Diffusion Layers (GDLs), to construct a Cell Stack.

Various metallic materials have been evaluated and/or used in the earlier generations of MBPPs for prototype or low-volume productions, including primarily Titanium, Nickel, Aluminum, and their alloys, and more recently Stainless Steels. The intensive applications of sheet Stainless Steels for MBPPs are driven by the significant cost savings relative to Titanium, Nickel and their alloys in both material and manufacturing costs, the superior electrical conductivity and corrosion resistivity vs. Aluminum and its alloys, and the superior manufacturability and more commercial availability of various grades, gages and coil widths vs. Titanium, Nickel, Aluminum, and their alloys.

Most recently, forming of thin metal sheets has found increasing applications in MBPP manufacturing, replacing the expensive and low-throughput manufacturing processes used in the earlier MBPP generations, such as machining or photoetching of thick metal slabs. In addition to the cost- and manufacturing-effectiveness, another notable advantage of sheet metal forming is its capability of making thinner metal plates, resulting in more compact stacks and modules desirable for applications in the automotive vehicle propulsion systems.

Throughout one or more embodiments of the present invention, the term “formability” refers to the capability of a sheet metal to be shaped or formed by plastic deformation and hence is primarily a measure of sheet metal material properties, such as yield and ultimate tensile strengths, total elongation, n-value and R-value, whereas the term “manufacturability” refers to the degree of ease to manufacture a product, for example, joining metal plates into MBPPs, stacking MBPPs into a fuel cell stack, and assembling fuel cell stacks into a fuel cell module.

In spite of the tremendous advances described above, continuously increasing requirements demand even more compact stacks with even higher performance and longer life time. There have been unmet needs in the materials and manufacturing processes of MBPPs for even higher corrosion resistance at lower cost, even lower interfacial electrical contact resistance with slower degradation or better durability, and even better formability and manufacturability.

Unfortunately, once a passivation film forms on a metal plate surface in the harsh corrosive environment encountered in a typical PEMFC, the interfacial electrical contact resistance increases, and the leached metallic ions may poison the PEM, causing degradation of the MBPP and PEM, and deterioration of the cell performance and durability. To eliminate or at least alleviate both the contact resistance and corrosion issues, a potential remedy is to coat the metal surface with a protective film which should be (1) highly conductive, (2) of minimal interfacial electrical contact resistance, (3) corrosion-resistant, and (4) adherent to the metal plate surface during fuel cell operations throughout the designed service life time.

It has been discovered that particular strategies may be employed to select appropriate coating/substrate materials and an appropriate coating process for maximizing the advantages of the selected functional materials and coating process in order to meet or exceed the ever increasing requirements on MBPPs in PEMFC applications.

It has been further discovered that material selection strategies may be defined, wherein the material for the relatively thinner coating layer is designed in such a strategy to achieve the best corrosion resistance and lowest interfacial electrical contact resistance at adequate formability and acceptable cost, whereas the material for the relatively thicker sheet metal is selected in such a strategy to attain the best formability/manufacturability and lowest cost with adequate corrosion resistance and electrochemical properties required in MBPP applications. These material selection strategies allow to optimize the utilization of various functional materials, tailored to take advantage of the merits of each material, while minimizing material and processing costs.

Accordingly, some lower-cost Stainless Steels may be utilized for the thin metal sheet to form MBPPs, due primarily to their lower material and manufacturing costs, superior formability, good thermal and electrical conductivities, and adequate corrosion resistance and electrochemical properties, as compared to Titanium- and Nickel-based alloys.

Early transition metal elements such as Titanium, Zirconium, Molybdenum, Vanadium and Niobium may be used to form a thin, adherent oxide layer that passivates the underlying thin metal sheet against corrosion in low pH environment while offering adequate interfacial electrical contact conductivity. Among the early transition metals, Niobium exhibits the best resistance to sulfuric acid that is the prevailing composition of the liquid environment within a PEMFC. Thus, Niobium may be used as a metal of choice for the metal cladding layer in PEMFC MBPP applications.

According to the embodiment of the material selection strategies discovered herein, the early transition metals such as Niobium, in addition to Nickel and some noble metals such as Gold, may be considered as coating materials (that is, candidate metals for cladding layers) on thin sheets of the Stainless Steels. In practice, the cladding layers on Nickel-clad Stainless Steels and Niobium-clad Stainless Steels are relatively thicker, in the range of tens of micrometers (currently 25 to 75 micrometers (μm)), whereas the thickness of the Gold cladding layers on Gold-clad Stainless Steels must be minimized to nano-scale in order to take full advantage of the expensive noble metal while minimizing the material cost.

It has been discovered that certain strategies may be implemented for selecting a coating process suitable to a particular coating application at hand.

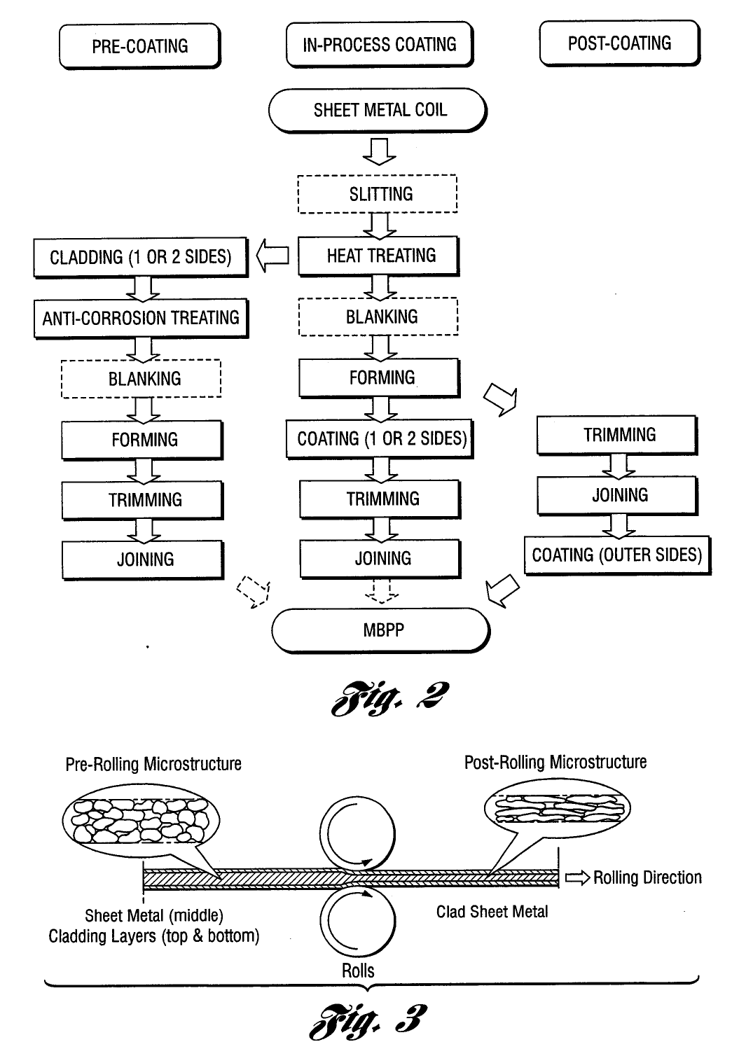

As illustrated in FIG. 2, there are three potential coating approaches for MBPP applications: (1) Pre-Coating, (2) In-Process-Coating, and (3) Post-Coating. Pre-Coating refers to a process wherein a coating is applied on a sheet metal prior to forming the sheet metal into single metal plates and subsequently joining the single metal plates into MBPPs. In-Process-Coating refers to a process wherein a coating is applied on single metal plates formed from an uncoated sheet metal prior to joining the single metal plates into MBPPs. Post-Coating refers to a process wherein a coating is applied on MBPPs formed from an uncoated sheet metal and joined thereafter, as a last step in a MBPP manufacturing process.

In FIG. 2, the process steps in dashed-line boxes denote the steps which may not necessarily occur. For example, if a sheet metal coil has a width which is close to the length of a metal plate, i.e., the coil width is 2″-4″ wider than the metal plate length, the slitting step is not needed; for mass production of metal plates using progressive dies, the blanking step is omitted while decoiling and coil feeding are required at a press; for prototyping or low-volume production of metal plates, a coil needs to be blanked first, the resultant blank stack needs to be destacked at a press, and the blanks need to be fed into a forming die manually. Automation mechanisms are normally used only for high-volume mass production. It should also be noted that some typical quality-assurance process steps for MBPPs, such as blank and plate inspections and leak testing, are not included in FIG. 2.

Each of the above-described three coating approaches exhibits both advantages and drawbacks in terms of cost, delivery, quality and performance.

It has been discovered that coating material cost typically counts for less than one third of the total coating cost. The coating process and its speed normally dominate the total coating cost. For those MBPP applications where the total cost is the foremost concern, scrutiny needs to be made into the selection of an appropriate coating process.

With regard to delivery or process speed, Pre-Coating has a remarkable advantage compared to In-Process-Coating or Post-Coating, i.e., presumably higher process speed/throughput, or lower cycle time of the entire MBPP manufacturing process. This is because Pre-Coating is applied on sheet metals normally in coil form at a higher speed, whereas the In-Process-Coating or the Post-Coating is conducted on metal plates, either one plate (or one surface) at a time or batch-wise, i.e., batch coating on a group of metal plates at a lower speed. In addition, the In-Process-Coating or the Post-Coating is normally applied on metal plates via vapor phase deposition which is a lower-speed process. The Pre-Coating may also involve vapor phase deposition. However, it would be conducted typically at a higher speed in a continuous process.

With regard to quality and performance, the In-Process-Coating and the Post-Coating exhibit several desirable advantages, including: (1) no negative effect on sheet metal formability, (2) more flexibility allowing sheet metals be heat treated prior to forming for better formability, (3) coverage of forming-induced surface defects, and (4) coverage of both forming-induced and joining-induced surface defects in case of the Post-Coating. The In-Process-Coating also allows coating on both sides of a single metal plate, i.e., coolant channel side and fuel and oxidant channel sides of a MBPP, whereas the Post-Coating can cover only fuel and oxidant channel sides of a MBPP. The Pre-Coating can be applied on either one side or both sides of a sheet metal, resulting in coating on either fuel and oxidant channel sides of a MBPP only, or fuel and oxidant channel sides plus coolant channel side of a MBPP. For all these three coating approaches, selective coating on the outer sides of a MBPP (i.e., fuel and oxidant channel sides of a MBPP) is feasible and commercially practical.

In addition to the notable lower process speed, the In-Process-Coating and the Post-Coating also exhibit some other potential problems, for example, (1) potential surface and structure damages during handling and coating of metal plates, (2) potential distortion of the coated metal plates due to the high temperatures during vapor phase deposition and the coating residual stresses typical of thin film coating, and (3) more geometrical variations than the Pre-Coating. Moreover, the In-Process-Coating requires more careful handling after the coating is applied and before joining, wherein alignment of the coated single metal plates in joining fixtures is challenging and may lead to even more geometrical variations. Additionally, for the In-Process-Coating, joining may create surface defects and damages to the coating which cannot be covered since the joining is after the coating and thus the last step in MBPP manufacturing. Overall, the Pre-Coating and the Post-Coating appear to offer more advantages than the In-Process-Coating.

The Pre-Coating may be conducted via various methods, one of which is Cladding. Although Cladding is the most frequently evaluated and commercially available process among the Pre-Coating methods, there are some severe drawbacks associated with the conventional Cladding process and the resultant clad sheet metals, notably, inferior formability as compared to the unclad sheet metals of same grades and gages. The inferior formability of the conventionally-clad sheet metals leads to relatively higher scrap rate during forming of the conventionally-clad sheet metals into MBPP geometries, and consequently relatively higher material and manufacturing costs. In addition, the inferior formability of the conventionally-clad sheet metals substantially narrows MBPP design window, limiting the applications of the conventionally-clad sheet metals to merely those MBPP designs with shallow and wide channels in active area and simple geometries in transition area. This in-turn raises significant restrictions to its applications in MBPP manufacturing for the automotive vehicle propulsion systems where light weight and compact fuel cell stacks are required for energy efficiency and packaging flexibility.

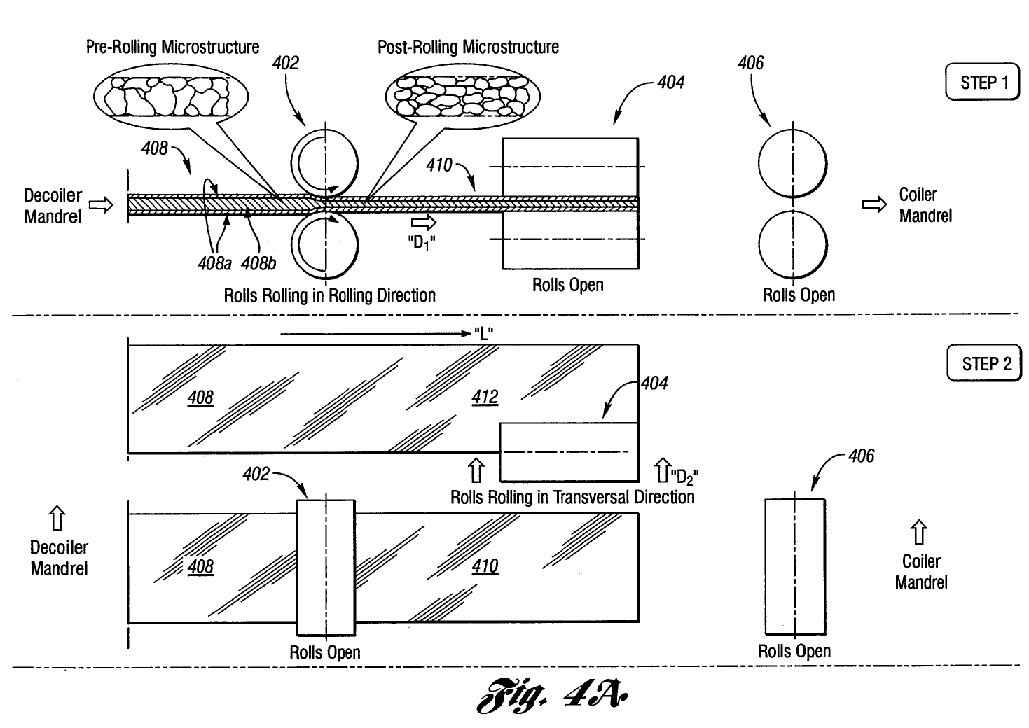

According to the embodiment of the mechanisms revealed herein, the inferior formability of the conventionally-clad Stainless Steels is attributable to several causes. Among them, the foremost cause is the extensive uniaxial pre-strain and the concomitant extreme anisotropy in grain microstructure and resultant material properties due to the extensive uniaxial rolling for gage reduction and cladding in the conventional Cladding process, as illustrated in FIG. 3. Also shown in FIG. 3 are the schematics of the microstructures before and after rolling in the Rolling Direction, i.e., pre-rolling microstructure and post-rolling microstructure, respectively. Thus, any measure which can eliminate the significant uniaxial pre-strain and extreme anisotropy in grain microstructure and resultant material properties will eventually improve the formability of the clad sheet metals.

According to at least one aspect of the present invention, a Skin Pass method is provided for cladding a thin metal sheet to enhance formability and manufacturability thereof. In certain particular embodiments, the resultant thin metal sandwich is particularly suitable for forming and manufacturing MBPPs in PEMFC applications.

In at least one embodiment of the Skin Pass method, at least one metal cladding layer is compressed onto a thin metal sheet by rolling with cylindrical rolls or by pressing using flat dies. The rolling or pressing is conducted typically at a higher pressure. In general, the pressure used depends on many factors, including (1) initial thicknesses, yield strengths and workhardenability of both the metal cladding layer and the thin metal sheet, (2) reduction ratio, (3) adhesion strength at the interface, (4) process temperature and speed, (5) cooling mechanism, and (6) coil width, among others.

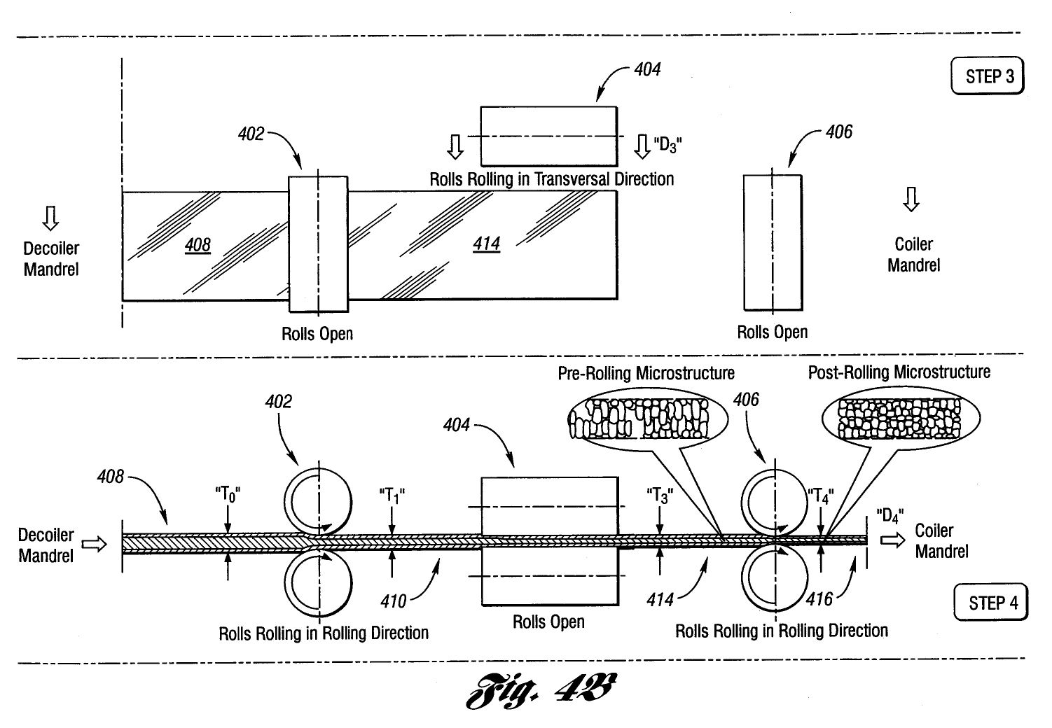

In at least another embodiment, and as illustrated in FIGS. 4A and 4B, the method includes contacting at least one metal cladding layer 408a with a thin metal sheet 408b to form a thin metal sandwich 408 having an original thickness “To”, subjecting the thin metal sandwich 408 to a first compression rolling in a first direction “D₁” to form a first compressed thin metal sandwich 410 having a first compressed thickness “T₁”, and subjecting the first compressed thin metal sandwich 410 to a second compression rolling in a second direction “D₂” different from the first direction “D₁” to form a second compressed thin metal sandwich 412 having a second compressed thickness (not shown). It should be noted that FIGS. 4A and 4B show an exemplary case at a lower total thickness reduction for illustration purpose.

In at least yet another embodiment, the method further includes subjecting the second compressed thin metal sandwich 412 to a third compression rolling in a third direction “D₃” different from the first or the second direction, “D₁” or “D₂”, to form a third compressed thin metal sandwich 414 having a third compressed thickness “T₃”.

In at least yet another embodiment, the method further includes subjecting the third compressed thin metal sandwich 414 to a fourth compression rolling in a fourth direction “D₄” different from at least two of the first, second and third directions to form a fourth compressed thin metal sandwich 416 having a fourth compressed thickness “T₄”.

In at least one particular embodiment, the first direction “D₁” is parallel to a longitudinal axis “L” of the thin metal sheet 408b. In at least another particular embodiment, the second direction “D₂” is transversal to the longitudinal axis “L” of the thin metal sheet 408b. In at least yet another particular embodiment, the third direction “D₃” is transversal to the longitudinal axis “L” of the thin metal sheet 408b and opposite to the second direction “D₂”. In at least yet another particular embodiment, the fourth direction “D₄” is parallel to the longitudinal axis “L” of the thin metal sheet 408b.

In at least yet another particular embodiment, a first thickness difference between the original and the first compressed thicknesses, “T₀” and “T₁”, is equal to a second thickness difference between the first and the second compressed thicknesses, “T₁” and “T₂”, and equal to a third thickness difference between the second and the third compressed thicknesses, “T₂” and “T₃”, and equal to a fourth thickness difference between the third and the fourth compressed thicknesses, “T₃” and “T₄”.

In at least yet another embodiment, the method further includes forming a metal plate from the fourth compressed thin metal sandwich.

According to the embodiment, the thin metal sheet may be made of any suitable corrosion-resistant metal materials, as thin as possible for the intended use in a FCV. As described above, the material selection strategies discovered herein may be used for selecting an appropriate thin metal sheet of superior formability and lower cost as well as other material properties required in FCV applications. In certain particular instances, the thin metal sheet may be made of one of the Stainless Steels.

According to the embodiment, the metal cladding layer may be made of any suitable corrosion-resistant metals but typically one of the early transition metals, preferably Niobium, or Nickel, or one of the noble metals, such as Gold, in accordance with the material selection strategies discovered herein, as detailed above.

In at least yet another embodiment, the metal cladding layer may be a thin metal foil or a plated or deposited thin metal film, with a thickness typical of a thin foil or an ultra thin film, depending on the material used. For example, the thickness of the metal cladding layer may be less than 30 percent of the thickness of the thin metal sheet if an early transition metal is used for the cladding layer, or far less than one (1) percent of the thickness of the thin metal sheet if a noble metal is used for the cladding layer. Furthermore, the metal cladding layer may be on either one side or both sides of the thin metal sheet to be Skin-Pass processed, and the coverage on the thin metal sheet may be complete or partial in either case.

The entire Skin Pass process effectuates a total thickness Reduction Ratio, Rₜ, defined as a ratio of the total thicknesses reduction, T₀-T₄, to the original thickness, T₀, of the thin metal sandwich:

$$Rt = \frac{{T}_{0} - {T}_{4}}{{T}_{0}}$$

In general, the value of Rₜ depends on the initial thicknesses and material properties of both the thin metal sheet and cladding layer(s), the required adhesion strength between them, and the required final thicknesses and material properties of the sheet and cladding layer(s). In certain particular embodiment, Rₜ is within the range of 5 to 50 percent.

The compression rolling may be conducted at room temperature or elevated temperatures to lower the pressure needed for deforming the cladding layer(s) and thin metal sheet, and to allow a higher Reduction Ratio. The temperature, however, should not be too high to avoid mass diffusion of the cladding material into the thin metal sheet.

In at least one particular embodiment, the Skin Pass method includes four (4) steps, as collectively shown in FIGS. 4A and 4B, wherein Steps 1 and 4 illustrate the side view, whereas Steps 2 and 3 depict the top view of the layout and transfer movement of rolls and mandrels as well as the thin metal sheet and cladding layers. Also shown in FIGS. 4A and 4B are the schematics of the microstructures before and after Skin Pass steps in the Rolling and Transversal Directions, respectively.

In certain particular instances and as illustratively shown in FIGS. 4A and 4B, three (3) pairs of rolls are used. The first and last pairs are for Steps 1 and 4. They are aligned with a line in the Rolling Direction, also known as Coil Length Direction, which is parallel to the longitudinal axis of the thin metal sheet 408b, referred to as Rolling Line hereafter. The middle rolls in the Transversal Direction, which are offset from the Rolling Line, are for Steps 2 and 3.

In at least yet another embodiment of the Skin Pass method, the four steps in the Skin Pass process are provided in detail as follows.

Step 1:

The Skin Pass process starts from the compression rolling in the Rolling Direction for a thickness reduction ratio of 25 percent of Rₜ, where the total thickness Reduction Ratio Rₜ is within the range of 5 to 50 percent, as described above. The thin metal sandwich 408 is shown to have at least one metal cladding layer 408a in contact with a thin metal sheet 408b. It is appreciated that the thin metal sandwich 408 may contain only one metal cladding layer 408a or two metal cladding layers 408a.

In Step 1, the middle rolls 404 in the Transversal Direction and the last pair of rolls 406 in the Rolling Direction are open and still. When the thin metal sandwich 408 passes through the first pair of rolls 402 in the Rolling Direction and reaches the longitudinal position of the middle rolls 404, Step 2 starts.

Leveling and guiding rolls (not shown in FIGS. 4A and 4B) may be needed to guide the sheet metal sandwich 408 and to facilitate the transfer of the sheet metal sandwich between the compression rolls 402, 404 and 406.

Following Step 1 in the Rolling Direction, the originally larger, more isotropic grains resulted typically from heat treating (annealing) are elongated along the Rolling Direction while “breaking up” into smaller sub-grains due to the increase in the concentration of dislocations.

Step 2:

In Steps 2 and 3, all the rolls 402 and 406 in the Rolling Direction are open and still to allow the sheet metal sandwich 408 to transfer forth toward the middle rolls 404 in the Transversal Direction and subsequently back to the Rolling Line.

At the initiation of the Skin Pass process, this transfer may need to be conducted manually at the leading edge (also known as head) of the sheet metal sandwich 408 while the tail side of the sheet metal sandwich 408 is transferred with the decoiler via a rail along the Transversal Direction. Similarly, at the end of the Skin Pass process, the tail transfer in the Transversal Direction may need to be conducted manually while the head is transferred with the coiler via a rail along the Transversal Direction. During the Skin Pass process, when both the head and tail are wound on the coiler and decoiler mandrels, the sheet metal sandwich transfer in the Transversal Direction is accomplished by moving the mandrels via the rails along the Transversal Direction forth and back.

When the sheet metal sandwich 408 is moved forth through the middle rolls 404 in the Transversal Direction, the compression of the sheet metal sandwich 408 is designed to attain an incremental thickness reduction ratio of 25 percent of Rₜ per pass.

Step 3:

The sheet metal sandwich 408 is then roll-compressed by passing through the middle rolls 404 in the Transversal Direction backward toward the Rolling Line. This step is designed to achieve an incremental thickness reduction ratio of 25 percent of Rₜ per pass.

Following the two (2) Skin Pass steps in the Transversal Direction forth and back (Steps 2 and 3), the grains originally elongated in the Rolling Direction during Step 1 are now also elongated along the Transversal Direction while further breaking up into smaller sub-grains due to the increase in the concentration of dislocations.

Steps 1 to 3 repeat length-by-length until the sheet metal sandwich 408 reaches the last pair of rolls 406 in the Rolling Direction. Then, Step 4 starts. During the repeats of Steps 1 to 3, each transition from Step 1 to Step 2 is triggered by the completion of a rolling length of the sheet metal sandwich 408 equal to the length of the middle rolls 404; Step 3 sets in after the sheet metal sandwich 408 passes through the middle rolls 404 completely.

Step 4:

Step 4 is conducted in the Rolling Direction through the last pair of rolls 406 along the Rolling Line for a final incremental thickness reduction ratio of 25 percent of Rₜ. In this step, the middle rolls 404 in the Transversal Direction are opened to the opening same as the Step 2 opening and remain still, while the first pair of rolls 402 run with the last pair of rolls 406 simultaneously, rolling the sheet metal sandwich 408 in the Rolling Direction.

When the sheet metal sandwich 408 passes through the first and last pairs of rolls in the Rolling Direction for a length equal to that of the middle rolls, the first and last pairs of rolls open up and become still. Then, Step 2 sets in. Steps 1 to 4 repeat in this sequence until the sheet metal sandwich 408 is exhausted.

Following the last Skin Pass step in the Rolling Direction, the grains previously elongated in the Transversal Direction during Step 3 are “rounded” or elongated slightly along the Rolling Direction while further breaking up into smaller sub-grains due to the further increase in the concentration of dislocations.

In at least yet another embodiment of the Skin Pass method, to obtain a superior formability of the clad sheet metal, a lower Reduction Ratio in the Skin Pass process is preferred. However, this may reduce the mechanical bonding or adhesion strength between the cladding material and thin metal sheet. Therefore, some degree of chemical or metallurgical bonding combined with the mechanical bonding should be considered to optimize the formability and adhesion.

According to the embodiments of the Skin Pass method, use of the four steps in the Skin Pass method eliminates the extreme anisotropy in the microstructure of the clad sheet metal, i.e., the very large length-to-width aspect ratio in grain size, caused by the extensive uniaxial rolling for gage reduction and cladding in the conventional Cladding process. This in-turn eliminates the extreme anisotropy in the material properties of the clad sheet metal and reduces the substantial loss in total elongation and stretchability in the Rolling Direction. In addition, the Skin Pass method also reduces the significant uniaxial pre-strain and thus increases the limit of available amount of further strains in a subsequent forming operation under unbalanced biaxial tension and plane strain conditions. As a result, the safe zone in the forming limit diagram is enlarged because the major strain limit in the Rolling Direction is shifted upwards. Consequently, the need for annealing after Skin Pass is largely diminished, avoiding mass diffusion of the cladding material into the thin metal sheet and formation of brittle intermetallics at the interface if an early transition metal is used for the cladding layer(s), or loss or reduction of corrosion resistivity if a noble metal is used for the cladding layer(s).

While the best mode for carrying out the invention has been described in detail, those familiar with the art to which this invention relates will recognize various alternative designs and embodiments for practicing the invention as defined by the following claims.

What is claimed:

1. A method for cladding a thin metal sheet for enhanced formability and manufacturability, comprising:
contacting at least one metal cladding layer with a thin metal sheet to form a thin metal sandwich having an original thickness, wherein the metal cladding layer may be a thin metal foil or a plated or deposited thin metal film;
subjecting the thin metal sandwich to a first compression rolling in a first direction to form a first compressed thin metal sandwich having a first compressed thickness; and
subjecting the first compressed thin metal sandwich to a second compression rolling in a second direction different from the first direction to form a second compressed thin metal sandwich having a second compressed thickness.

2. The method of claim 1, further comprising subjecting the second compressed thin metal sandwich to a third compression rolling in a third direction different from the first or the second direction to form a third compressed thin metal sandwich having a third compressed thickness.

3. The method of claim 2, further comprising subjecting the third compressed thin metal sandwich to a fourth compression rolling in a fourth direction different from at least two of the first, second and third directions to form a fourth compressed thin metal sandwich having a fourth compressed thickness.

4. The method of claim 1, wherein the first direction is parallel to a longitudinal axis of the thin metal sheet.

5. The method of claim 1, wherein the second direction is transversal to the longitudinal axis of the thin metal sheet.

6. The method of claim 2, wherein the third direction is transversal to the longitudinal axis of the thin metal sheet and opposite to the second direction.

7. The method of claim 3, wherein the fourth direction is parallel to the longitudinal axis of the thin metal sheet.

8. The method of claim 1, wherein a first thickness difference between the original thickness and the first compressed thickness is equal to a second thickness difference between the first and the second compressed thicknesses.

9. The method of claim 2, wherein the first thickness difference is equal to a third thickness difference between the second and the third compressed thicknesses.

10. The method of claim 3, wherein the first thickness difference is equal to a fourth thickness difference between the third and the fourth compressed thicknesses.

11. The method of claim 1, wherein the fourth compressed thickness is 95 to 50 percent of the original thickness of the thin metal sandwich.

12. The method of claim 1, wherein an incremental thickness reduction ratio of 25 percent of the total thickness Reduction Ratio, Rₜ, is attained per each compression rolling, with Rₜ ranging from 5 to 50 percent.

13. A method for improving formability and manufacturability of a thin metal sheet to be used for forming a metal plate and manufacturing a metal bi-polar plate thereof, comprising:
contacting at least one metal cladding layer with a thin metal sheet to form a thin metal sandwich having an original thickness, wherein the metal cladding layer may be a thin metal foil or a plated or deposited thin metal film;
subjecting the thin metal sandwich to a first compression rolling in a first direction to form a first compressed thin metal sandwich having a first compressed thickness;
subjecting the first compressed thin metal sandwich to a second compression rolling in a second direction different from the first direction to form a second compressed thin metal sandwich having a second compressed thickness;
subjecting the second compressed thin metal sandwich to a third compression rolling in a third direction different from the first or the second direction to form a third compressed thin metal sandwich having a third compressed thickness; and
subjecting the third compressed thin metal sandwich to a fourth compression rolling in a fourth direction different from at least two of the first, second and third directions to form a fourth compressed thin metal sandwich having a fourth compressed thickness.

14. The method of claim 13, wherein the first direction is parallel to a longitudinal axis of the thin metal sheet.

15. The method of claim 13, wherein the second direction is transversal to the longitudinal axis of the thin metal sheet.

16. The method of claim 13, wherein the third direction is transversal to the longitudinal axis of the thin metal sheet and opposite to the second direction.

17. The method of claim 13, wherein the fourth direction is parallel to the longitudinal axis of the thin metal sheet.

18. The method of claim 13, wherein a first thickness difference between the original thickness and the first compressed thickness is equal to a second thickness difference between the first and the second compressed thicknesses, and equal to a third thickness difference between the second and the third compressed thicknesses, and equal to a fourth thickness difference between the third and the fourth compressed thicknesses, and the fourth compressed thickness is 95 to 50 percent of the original thickness of the thin metal sandwich.

19. The method of claim 13, wherein an incremental thickness reduction ratio of 25 percent of the total thickness Reduction Ratio, Rₜ, is achieved per each compression rolling, with Rₜ ranging from 5 to 50 percent.

20. A multi-directionally compression-rolled clad sheet metal for enhanced formability and manufacturability thereof, formed by a method comprising:
contacting at least one metal cladding layer with a thin metal sheet to form a thin metal sandwich having an original thickness, wherein the metal cladding layer may be a thin metal foil or a plated or deposited thin metal film;
subjecting the thin metal sandwich to a first compression rolling in a first direction to form a first compressed thin metal sandwich having a first compressed thickness; and
subjecting the first compressed thin metal sandwich to a second compression rolling in a second direction different from the first direction to form a second compressed thin metal sandwich having a second compressed thickness.

21. The multi-directionally compression-rolled clad sheet metal of claim 20, wherein the method further comprising subjecting the second compressed thin metal sandwich to a third compression rolling in a third direction different from the first or the second direction to form a third compressed thin metal sandwich having a third compressed thickness.

22. The multi-directionally compression-rolled clad sheet metal of claim 20, wherein the method further comprising subjecting the third compressed thin metal sandwich to a fourth compression rolling in a fourth direction different from at least two of the first, second and third directions to form a fourth compressed thin metal sandwich having a fourth compressed thickness.

23. The multi-directionally compression-rolled clad sheet metal of claim 20, wherein the clad sheet metal is provided with substantially reduced anisotrophy in grain structure relative to a sheet metal counterpart subjected to compression rolling in only one direction.

24. A metal bi-polar plate formed from the multi-directionally compression-rolled clad sheet metal of claim 20.

25. A multi-directionally compression-rolled clad sheet metal having substantially reduced anisotrophy in grain structure relative to a sheet metal counterpart compression rolled in only one direction.

26. The multi-directionally compression-rolled clad sheet metal of claim 25 further comprising at least one metal cladding layer in overlaying contact with the clad sheet metal.
